(19) United States
(12) Patent Application Publication
(10) Pub. No.: US 2026/0268290 A1
(43) Pub. Date: Sep. 10, 2026

(54) SYSTEMS AND METHODS FOR MATCHING USERS OVER A COMPUTER NETWORK

(71) Applicant: Vianet Management, LLC, Scottsdale, AZ (US)

(72) Inventor: Jeff Steinport, Scottsdale, AZ (US)

(73) Assignee: Vianet Management LLC, Scottsdale, AZ (US)

(21) Appl. No.: 19/535,332

(22) Filed: Feb. 10, 2026

Related U.S. Application Data
(60) Provisional application No. 63/768,735, filed on Mar. 7, 2025.

(51) Int. Cl. G06Q 10/40

(52) U.S. Cl. CPC G06Q 10/40

(57) ABSTRACT

Systems and methods for matching users over a computer network. One or more processors execute instructions stored in one or more non-transitory memories to coordinate display of prompts on a user device, receive prompt answers from users, and calculate trait scores based on the prompt answers. The processors calculate compatibility scores between a first user and a second user using the trait scores, optionally apply reverse scoring and weighting algorithms to the prompt answers, trait scores, and/or compatibility scores, and normalize the compatibility scores to generate normalized compatibility scores indicative of user compatibility. The processors further coordinate displaying the normalized compatibility scores via a graphical user interface, including as a compatibility percentage and/or other visual indicators. The techniques can use dynamically updated information to reduce reliance on stale data and to support scalable matching across a population.

### CROSS REFERENCE TO RELATED APPLICATIONS

This application claims priority to, and the benefit of, U.S. Provisional Patent Application Ser. No. 63/768,735, entitled “SYSTEMS AND METHODS FOR MATCHING USERS OVER A COMPUTER NETWORK,” filed on Mar. 7, 2025, which is hereby incorporated by reference in its entirety for all purposes.

### TECHNICAL FIELD

This disclosure relates generally to matching algorithms and more particularly to matching algorithms using user personality traits to match users.

### BACKGROUND

Determining a suitable personality match between two potential roommates presents various challenges. Traditional methods for selecting roommates often rely on limited and subjective criteria, such as shared interests, lifestyle preferences, or basic compatibility questionnaires. These methods may not comprehensively account for deeper personality traits, behavioral tendencies, or interpersonal dynamics that contribute to a harmonious living arrangement. One challenge associated with personality-based roommate matching is the reliance on self-reported information. Individuals may unintentionally or intentionally misrepresent their habits, social preferences, or personal characteristics, leading to mismatches. Additionally, even when accurate information is provided, existing methods may lack the analytical capability to assess the nuances of compatibility effectively. Another issue arises from the subjective nature of evaluating personality traits. Standardized personality assessments may provide general insights into an individual's disposition but may not be specifically tailored to the context of cohabitation. Factors such as communication styles, conflict resolution tendencies, and daily routines can significantly impact the success of a roommate relationship but may not be adequately addressed in conventional matching systems. Moreover, current solutions often fail to leverage advancements in data analysis that could improve the accuracy of personality-based roommate matching. Many traditional approaches do not integrate real-time feedback or ongoing assessments, limiting their ability to refine and improve matches based on actual living experiences.

The ability to determine a match between two individuals over a computer network presents numerous technical challenges, particularly as the volume of data and user interactions continue to grow. Modern computer networks often involve complex systems that aggregate and process vast amounts of data to identify potential matches based on predefined criteria. Despite advances in computing and network technologies, the process of identifying matches in an efficient and reliable manner remains difficult due to several problems. Ensuring the accuracy and relevance of a matching process requires effective data integration and analysis. Users often provide diverse sets of information, which may include structured data (e.g., predefined preferences) and unstructured data (e.g., textual inputs and/or behavioral patterns). Handling these heterogeneous data types and ensuring compatibility during processing adds significant complexity to the matching algorithm, thereby putting undue burdens on processors running the matching algorithm. Latency associated with processing and responding to user inputs in real-time is another concern. Matching systems can balance computational demands with a need for prompt responses, particularly in high-traffic environments where delays can negatively impact the user experience. In traditional systems, increased computational demands can delay responses timing. In addition to a degradation of the user experience, delays in response times during high latency events can make past matching algorithms difficult to scale efficiently. Data inconsistencies, incomplete profiles, and/or erroneous user inputs can also introduce challenges in ensuring reliable matches. Mismatched or inaccurate data can lead to false positives or negatives, undermining an effectiveness of the matching system, thereby eroding user trust.

Therefore, in view of the above, there is a need for a new system and method for matching individuals using personality traits over a computer network.

Any discussion of problems and solutions has been included in this disclosure solely for the purposes of providing a context for the present disclosure, and should not be taken as an admission that any or all of the discussion was known at the time the disclosure was made

### SUMMARY

A number of embodiments can include a system. The system can include one or more processors and one or more non-transitory computer-readable storage devices. The one or more non-transitory computer-readable storage devices can store computing instructions. The computing instructions can be configured to communicate with the one or more processors and cause the one or more processors to perform receiving one or more prompt answers to one or more prompts from a user device, calculating one or more trait scores using the one or more prompts, calculating one or more compatibility scores between a first user and a second user, normalizing the one or more compatibility scores, and/or coordinating displaying the one or more normalized compatibility scores.

Various embodiments include a method. The method can be implemented via execution of computing instructions configured to run at one or more processors and/or configured to be stored at non-transitory computer-readable media. The method can comprise receiving one or more prompt answers to one or more prompts from a user device, calculating one or more trait scores using the one or more prompts, calculating one or more compatibility scores between a first user and a second user, normalizing the one or more compatibility scores, and/or coordinating displaying the one or more normalized compatibility scores.

Various embodiments can include an article of manufacture. The article of manufacture can include a non-transitory, tangible computer readable storage medium. The non-transitory, tangible computer readable storage medium can store instructions that, in response to execution by a computer, cause the computer to perform operations comprising receiving one or more prompt answers to one or more prompts from a user device, calculating one or more trait scores using the one or more prompts, calculating one or more compatibility scores between a first user and a second user, normalizing the one or more compatibility scores, and/or coordinating displaying the one or more normalized compatibility scores.

### BRIEF DESCRIPTION OF THE DRAWINGS

The subject matter of the present disclosure is particularly pointed out and distinctly claimed in the concluding portion of the specification. A more complete understanding of the present disclosure, however, may best be obtained by referring to the detailed description and claims when considered in connection with the drawing figures.

FIG. 1 illustrates a flowchart for a method, according to an embodiment.

FIG. 2 illustrates a representative block diagram of a computer network, according to an embodiment.

FIG. 3 illustrates a representative block diagram of a computer system, according to an embodiment.

FIG. 4 illustrates an example graphical user interface of a computer system for matching users over a computer network, according to an embodiment.

FIG. 5 illustrates an example graphical user interface of a computer system for matching users over a computer network, according to an embodiment.

### DETAILED DESCRIPTION

In many embodiments, the techniques described herein can provide a practical application and several technological improvements. In some embodiments, the techniques described herein can provide for faster and less data intensive matches between users over a computer network. These techniques described herein can provide a significant improvement over conventional approaches of determining matches, such as using online white pages or classified sections to determine matches. In many embodiments, the techniques described herein can beneficially make determinations based on dynamic information that describes current conditions and/or conditions that have occurred during the same day of a need for a match. In this way, the techniques described herein can avoid problems with stale and/or outdated data by continually updating. In a number of embodiments, the techniques described herein can advantageously provide an improved experience of finding a roommate by using social science techniques. In many embodiments, the techniques described herein can be used continuously at a scale that cannot be reasonably performed using manual techniques or the human mind. For example, determining matches for a population of a geographic area can use too much data to be reasonably performed in the mind of a human. In a number of embodiments, the techniques described herein can solve a technical problem that arises only within the realm of computer networks, as matches are determined over a computer network.

System program instructions and/or controller instructions may be loaded onto a non-transitory, tangible computer-readable medium having instructions stored thereon that, in response to execution by a controller, cause the controller to perform various operations. The term “non-transitory” is to be understood to remove only propagating transitory signals per se from the claim scope and does not relinquish rights to all standard computer-readable media that are not only propagating transitory signals per se. Stated another way, the meaning of the term “non-transitory computer-readable medium” and “non-transitory computer-readable storage medium” should be construed to exclude only those types of transitory computer-readable media which were found in In Re Nuijten to fall outside the scope of patentable subject matter under 35 U.S.C. § 101.

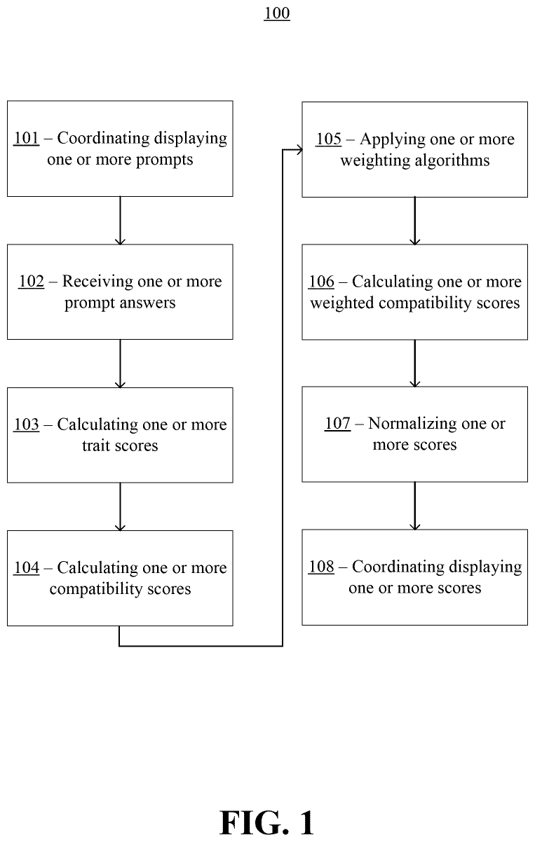

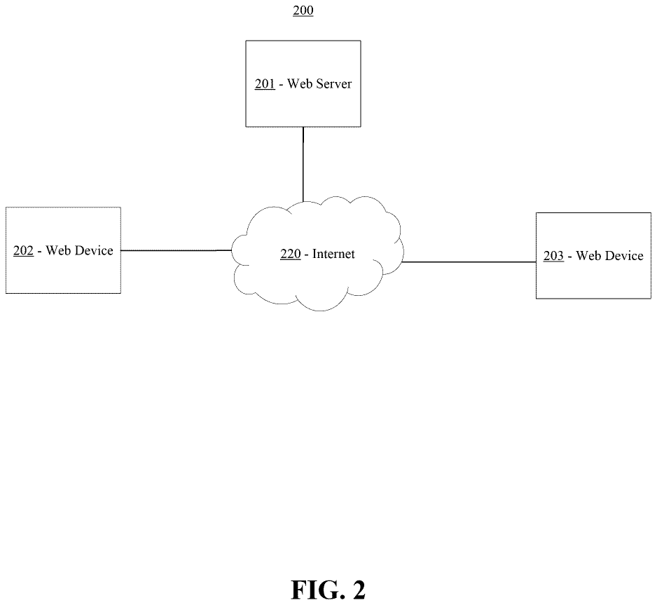

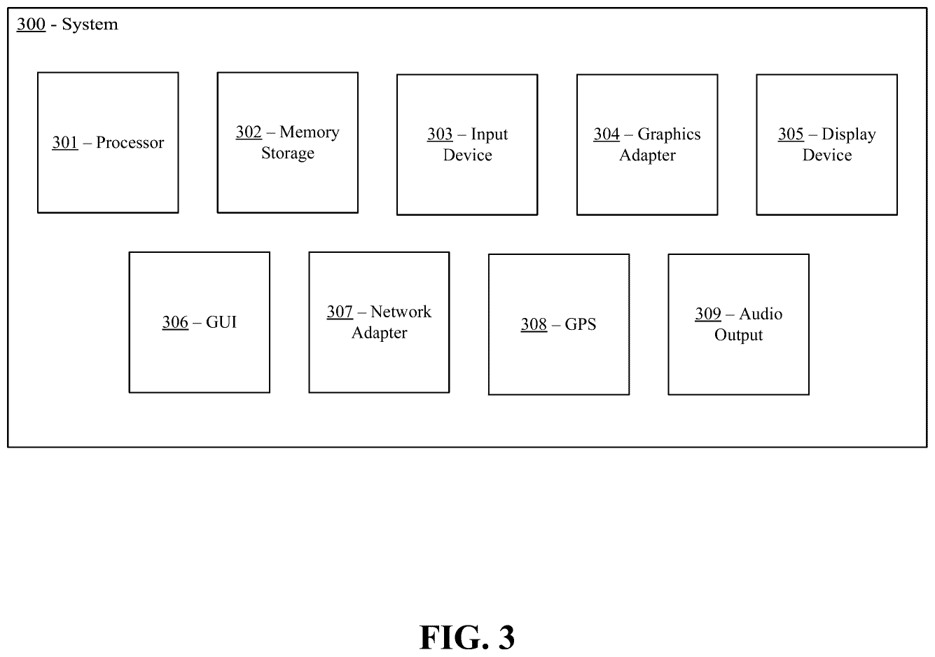

Turning ahead in the drawings, FIG. 1 illustrates a flow chart for a method 100, according to an embodiment. Method 100 is merely exemplary and is not limited to the embodiments presented herein. Method 100 can be employed in many different embodiments or examples not specifically depicted or described herein. In some embodiments, the activities of method 100 can be performed in the order presented. In other embodiments, the activities of method 100 can be performed in any suitable order. In still other embodiments, one or more of the activities of method 100 can be combined or skipped. In many embodiments, system 300 (FIG. 3) can be suitable to perform method 100 and/or one or more of the activities of method 100. In these or other embodiments, one or more of the activities of method 100 can be implemented as one or more computer instructions configured to run at one or more processing modules and configured to be stored at one or more non-transitory memory storage modules. Such non-transitory memory storage modules can be part of a computer system such as web server 201 (FIG. 2) and/or web devices 202, 203 (FIG. 2). The processing module(s) can be similar or identical to the processing module(s) described above with respect to computer system 300 (FIG. 3).

In many embodiments, method 100 can comprise a step 101 of coordinating displaying one or more prompts. One or more user prompts can be displayed on a user computing device (e.g., web devices 202, 203 (FIG. 2)). Coordinating displaying can comprise a number of different actions configured to display one or more prompts on a user device. In various embodiments, content can be rendered locally by a computing device's graphics processing unit or central processing unit. The computer system can receive content data from local memory and/or storage, processes it, and then generate pixel data for display on a connected screen. This method includes rendering text, images, video, and/or interactive graphical interfaces. In some embodiments, a centralized server (e.g., web server 201 (FIG. 2)) can manage display content across one or more user devices connected to a network (e.g., internet 220 (FIG. 2)). The server can receive display-related instructions from an application and/or a user interface, processes those instructions, and transmit rendering data to the user device. The server can also monitor display states and dynamically adjust parameters (e.g., resolution or frame rate) so that a display is consistent across user devices. Displaying can also be performed using a distributed model where individual user devices exchange data directly with one another. This peer-to-peer approach can employ protocols (e.g., distributed consensus algorithms) to ensure that all devices operate in a synchronized manner. In some embodiments, content display can comprise asynchronous updates, where portions of a display are refreshed independently. This approach minimizes latency and improves performance for applications requiring frequent updates to specific regions of the screen.

One or more prompts can be displayed on a user device in a number of different formats. In many embodiments, one or more prompts can be displayed as a static form comprising pre-defined fields for user input. The pre-defined fields can comprise text boxes, radio (e.g., option) buttons, checkboxes, dropdown menus, and/or other input elements. Fields may include input constraints, such as character limits or required formats, and display error messages or suggestions immediately upon invalid input. This method ensures data accuracy and guides users toward proper completion. The layout of the one or more prompts can be rendered using an HTML page and/or a desktop application window. One or more prompts can be displayed using a step-by-step and/or multi-page format, where users navigate through the prompts one prompt at a time. Navigation can be facilitated using buttons, such as “Next” and/or “Previous,” left and/or right arrows, and/or through a progress bar indicating the user's completion status. This approach can simplify complex questionnaires by dividing them into manageable portions. A sequence of one or more prompts can be dynamically adjusted based on user input and/or external factors. For example, selecting a particular response to an initial prompt may trigger the display of additional, related prompts. External factors can comprise localization of language and/or customization of questions based on user profiles or geographic location. Prompts can also be embedded as widgets and/or functionalities within a larger application or webpage (e.g., a webpage and/or application for location apartments). These widgets and/or functionalities can comprise collapsible sections, scrollable containers, and/or interactive tabs, thereby allowing users to engage with the questionnaire in a non-intrusive manner while maintaining access to other content. In many embodiments, one or more prompts can be presented through a voice-activated and/or conversational interface. Users can interact with the system via voice commands and/or text-based chat, allowing the user to respond to prompts sequentially as they are presented in natural language. These embodiments can use speech recognition and/or chatbot technology to provide an intuitive user experience.

In many embodiments, one or more prompts can comprise one or more personality tests. Personality tests can provide frameworks for categorizing user traits, behaviors, and tendencies into defined groups and/or dimensions. Users can be categorized into one or more personality classification systems by the one or more personality tests. Personality classification systems can include trait-based models and/or type-based models. Trait-based models can describe a participant's personality through specific characteristics or traits that are measurable and relatively stable over time. One example is the Five Factor Model (FFM). The FFM can identify at least five primary dimensions of personality: openness to experience, conscientiousness, extraversion, agreeableness, and/or neuroticism (e.g., emotional stability). Each dimension can be represented by a range of values, thereby allowing individuals to exhibit varying degrees of each trait. In many embodiments, the five primary dimensions of personality can be determined using the Ten Item Personality Inventory (TIPI). TIPI can comprise a personality test comprising ten prompts. In many embodiments, each prompt can correspond to at least one of five dimensions of personality. In various embodiments, each of the five personality dimensions can be represented by at least two prompts in a series of two or more prompts. Some prompts in a sequence can represent a positive pole of a dimension, and the other prompts can measure a negative pole of the dimension. For example, extraversion can be determined using one prompt reflecting high extraversion (e.g., sociability or outgoingness) and another prompt reflecting low extraversion (e.g., introversion). This approach can ensure that each dimension is evaluated comprehensively and balances opposing traits within the dimension.

Type-based systems classify individuals into discrete personality categories. The Myers-Briggs Type Indicator (MBTI) is one of the most widely recognized type-based systems. MBTI can categorize individuals along four metrics: extraversion versus introversion, sensing versus intuition, thinking versus feeling, and judging versus perceiving. The MBTI metrics can be combined to form sixteen or more personality types. Another type-based system, known as the Enneagram system, can assign individuals to one of nine interconnected personality types based on core motivations and behavioral patterns.

In many embodiments, method 100 can comprise a step 102 of receiving one or more prompt answers. Prompt answers can comprise responses to prompts from one or more users (e.g., responses to prompts described in step 101). Users can respond to each prompt by indicating an agreeableness between and/or including strong disagreement or strong agreement. For example, users can select a radio button, checkbox, dropdown menu item, and/or other input element corresponding to their agreeableness. As another example, a user can enter a description of their agreeableness using a keyboard as a response. As a further example, a user can speak a description of their agreeableness into a microphone, which can be stored and/or streamed as an audio file or converted into natural language text using one or more speech recognition and/or transcription algorithms. In embodiments where natural language is used to respond to a prompt, speech recognition software and/or natural language processing (NLP) software can be used to interpret and/or score the prompt. Speech recognition software can convert spoken language into written text using a combination of signal processing, machine learning, and NLP software. Speech-to-text software can be used to transcribe spoken prompt responses. NLP software enables machines to analyze, interpret, and generate human language. NLP software can use a one or more of computational linguistics, machine learning, and/or statistical methods to process and understand text or speech data. One or more sentiment analysis algorithms (e.g., rules based and/or machine learning based) can be used to score natural language prompt responses. The responses can be scored to determine a value for each personality dimension and/or metric. In many embodiments, higher scores can indicate a stronger presence for an associated trait, while lower scores indicate a weaker presence of the associated trait. In various embodiments, lower scores can indicate a stronger presence for an associated trait, while higher scores indicate a weaker presence of the associated trait. Prompt answers can be stored in one or more databases and/or in one or more arrays.

In many embodiments, method 100 can comprise a step 103 of calculating one or more trait scores. Trait scores can be calculated using one or more answers. For example, the one or more answers can be inputted into one or more trait score calculation equations. Raw scores for certain prompts can have a one or more reverse score functions applied to them before one or more trait scores can be calculated. A reverse score function can be used as a method to normalize values for prompts configured to test opposite poles of a personality dimension and/or metric. In this way, prompt answers can be compared on a more even basis. In many embodiments, a reverse score function can comprise subtracting a score for a prompt from a maximum value for the prompt. In the same or different embodiments, a reverse score function can comprise taking an absolute value for one or more answers. In many embodiments, a reverse score function can comprise adding a score for a prompt to a minimum score for a prompt. Scores for one or more questions can be summed together and/or divided by a number of questions for a trait.

In many embodiments, method 100 can comprise a step 104 of calculating one or more compatibility scores. Compatibility scores can be used to determine a match between two users. Compatible users can comprise users with similar and/or complementary scores for personality dimensions and/or metrics. Compatibility scores can be calculated on a per trait level, user pair level, as similarity score, and/or as a complementary score. Similarity scores between two users can be determined by subtracting trait scores for a metric and/or dimension. Scores that are closer to zero can indicate an increased similarity. In an alternate embodiment, similarity scores between two users can be determined by adding trait scores for a dimension and/or metric. Larger scores can indicate an increased similarity. Complementary scores between two users can indicate a compatibility between two or more complementary individuals. For example, extroverts can be matched with introverts using a complementary score. In many embodiments, a user can supply a customized compatibility score calculation. In this way, preferences of a user can be taken into account when matching individuals.

In many embodiments, method 100 can comprise a step 105 of applying one or more weighting algorithms. Step 105 can be performed after, at a same time as and/or as a part of step 104. Weighting algorithms can be applied to trait scores and/or compatibility scores to increase an importance of a trait score in later calculations. In many embodiments, a weighting algorithm can assign an importance to each trait score using a numerical modifier. For example, a most important trait can be assigned a highest modifier and a least important trait can be assigned a lowest modifier. In some embodiments, a ranking of traits can be received from a user device so that a user can create a customized weighting algorithm. Numerical modifiers can be applied to trait scores and/or compatibility scores by multiplying and/or adding the numerical modifier to the score. Additional, alternative, and/or more complex operations can also be received from a user device so that a user can create a customized weighting algorithm. In many embodiments, numerical modifiers can add up to a predefined sum (e.g., 1) to ensure consistency among calculations. In some embodiments, user defined numerical modifiers can validated by summing them. User defined numerical modifiers that sum to the predefined sum can be determined valid and user defined numerical modifiers that do not sum to the predefined sum can be determined invalid and/or be returned to the user for modification.

In many embodiments, method 100 can comprise a step 106 of calculating one or more weighted compatibility scores. Step 106 can be performed after, at a same time as and/or as a part of one or more of steps 104-105. Weighted similarity scores can be calculated on a per trait level and/or user pair level. Weights can be received from a user as a numerical value using one or more GUI elements. For example, a weight can be typed into a text box, selected on a slider or knob, selected as a categorical selection, etc. Weightings can be applied in a variety of ways. For example, weights can be applied through linear scaling and/or categorical weighting. In some embodiments, a linear weighting approach can be used. Each trait score can be multiplied by a predefined weighting factor. Many embodiments can use categorical weighting, in which different categories of scores receive distinct weights. For instance, a scoring system may categorize trait scores into groups, such as high-priority, medium-priority, and/or low-priority. Each group can receive a specific weighting factor.

In many embodiments, method 100 can comprise a step 107 of normalizing one or more compatibility scores. In some embodiments, one or more of a trait score and/or a compatibility score can be normalized in step 107. Normalization of scores can provide for a number of technical advantages over non-normalized scores. For example, normalization can eliminate redundancy, eliminate anomalies and/or outliers, and/or facilitate consistency between scores and/or users. In various embodiments, normalization of scores can enhance storage of prompt responses, trait scores, and/or a compatibility scores by creating smaller and/or more focused tables for storage in a database. In this way, burdens on processing and/or storage devices can be lessened. Normalization of a score can convert the score into a compatibility percentage indicating a percent compatibility between two users. A higher percentage can indicate a more compatible match. In some embodiments, a normalization algorithm can comprise determining a maximum score for a trait score and/or a compatibility score. In various embodiments, a normalization algorithm can sum trait scores and/or a compatibility scores for different personality dimensions and/or metrics to get a measure of a total compatibility for a pair of users. The normalization algorithm can then use the following equation to determine a compatibility percentage:

$$Compatibility \% = ( \frac{Total Compatibility}{Maximum Score} ) 100$$

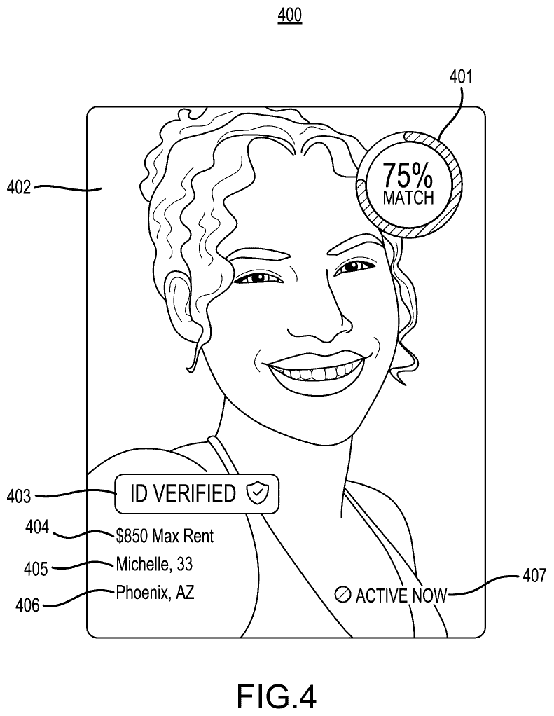

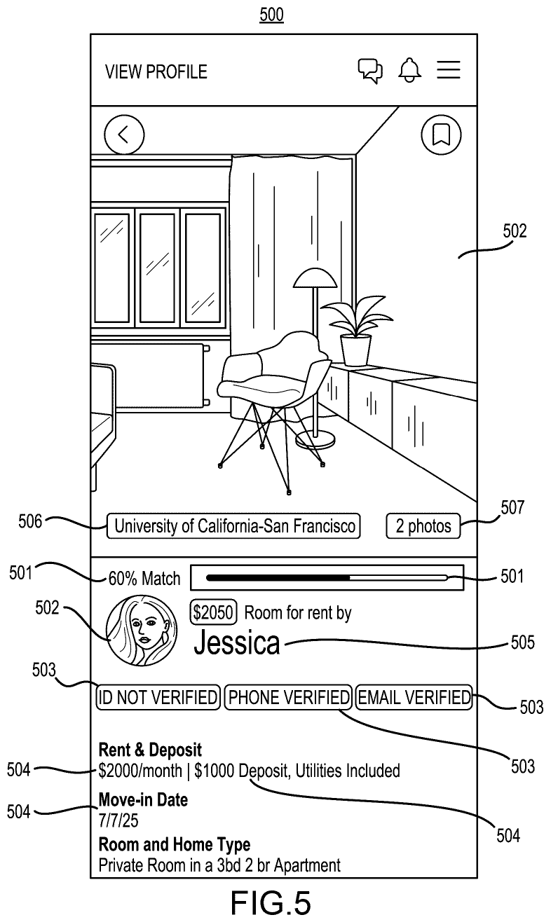

In many embodiments, method 100 can comprise a step 108 of coordinating displaying one or more scores. In various embodiments, one or more scores can have their display coordinated similar to one or more prompts, as described with reference to step 101. In some embodiments, scores can be displayed on a website (e.g., an apartment and/or roommate finding website). Turning now to FIG. 4, an embodiment of a GUI 400 is shown. GUI 400 is merely exemplary and is not limited to the embodiments presented herein. GUI 400 can be employed in many different embodiments or examples not specifically depicted or described herein. In some embodiments, the elements of GUI 400 can be arranged as shown in FIG. 4. In other embodiments, the elements of GUI 400 can be arranged in any suitable arrangement. In still other embodiments, one or more of the activities of GUI 400 can be combined or omitted. In many embodiments, system 300 (FIG. 3) can be suitable for coordinating displaying GUI 400 and/or one or more elements of GUI 400. In these or other embodiments, one or more elements of GUI 400 can be implemented as one or more computer instructions configured to run at one or more processing modules and configured to be stored at one or more non-transitory memory storage modules. Such non-transitory memory storage modules can be part of a computer system such as web server 201 and/or web devices 202-203 (FIG. 2). The processing module(s) can be similar or identical to the processing module(s) described above with respect to computer system 300 (FIG. 3). In many embodiments, GUI 400 can comprise GUI 306 (FIG. 3). GUI 400 can comprise compatibility score 401, user image 402, one or more badges 403, match qualification 404, user information 405, user location 406, and/or user activity indicator 407. Compatibility score 401 can be displayed as a number followed by the percent symbol (%), as a decimal, as a fraction, as a pie chart, as a bar graph, and/or as a progress bar. User image 402 can be supplied by a user and can comprise an image to facilitate matching between users. For example, a user image can comprise an image of a user (e.g., user image 402) and/or an image of a dwelling (e.g., in FIG. 5). One or more badges 403 can indicate various qualities of a user in using a visual indicator. For example, badges 403 can indicate whether a user's ID has been verified, dietary preferences, smoking preferences, media preferences, political preferences, religious preferences, hobbies, personality dimensions, personality metrics, and many other qualities configured to aid in matching compatible users together. Match qualification 404 can comprise information that qualifies one or more users as a suitable match. For example, a periodic qualification (e.g., monthly, yearly, daily, etc.) can be displayed as match qualification 404. User information 405 can comprise one or more demographic qualities of a user. For example, user information 405 can comprise a username, age, race, gender, sex, and many other demographic qualities of a user. Location 406 can comprise a location of a user and/or a property. Location 406 can display a city, state, school, county/parish, country, GPS location, or many other location indicators at various levels of granularity. User activity indicator 407 can comprise in visual indication of whether a user is active on a website and/or application. In some embodiments, active and matched users can initiate one or more communication protocols (e.g., text chatting, audio chatting, video chatting, etc.) to facilitate a deeper and more certain match between users.

Turning now to FIG. 5, an embodiment of a GUI 500 is shown. GUI 500 is merely exemplary and is not limited to the embodiments presented herein. GUI 500 can be employed in many different embodiments or examples not specifically depicted or described herein. In some embodiments, the elements of GUI 500 can be arranged as shown in FIG. 5. In other embodiments, the elements of GUI 500 can be arranged in any suitable arrangement. In still other embodiments, one or more of the activities of GUI 500 can be combined or omitted. In many embodiments, system 300 (FIG. 3) can be suitable for coordinating displaying GUI 500 and/or one or more elements of GUI 500. In these or other embodiments, one or more elements of GUI 500 can be implemented as one or more computer instructions configured to run at one or more processing modules and configured to be stored at one or more non-transitory memory storage modules. Such non-transitory memory storage modules can be part of a computer system such as web server 201 (FIG. 2) and/or web devices 202-203 (FIG. 2). The processing module(s) can be similar or identical to the processing module(s) described above with respect to computer system 300 (FIG. 3). In many embodiments, GUI 500 can comprise GUI 306 (FIG. 3). GUI 500 can comprise compatibility score 501, user image 502, one or more badges 503, one or more match qualifications 504, user information 505, user location 506, and/or user photo indicator 507. In many embodiments, a plurality of user images 502 can be submitted. In some embodiments, a photo indicator 507 can display a number of submitted user images, which can be displayed in a gallery and/or swipeable format. Badges 503 can be displayed in an activated or inactivated state. A badge in an activated state can indicate that a user fulfills the badge while a badge in an inactive state indicates that a user does not fulfill the badge. Match qualification 504 can comprise a one time qualification and/or a qualification occurring on a specified date. Match qualification 504 can comprise a rent value, a deposit value, a move in date, and/or any other suitable match qualification.

FIG. 2 illustrates a block diagram of a system 200 that can be employed for matching users over a computer network, as described in greater detail below. System 200 is merely exemplary and embodiments of the system are not limited to the embodiments presented herein. System 200 can be employed in many different embodiments or examples not specifically depicted or described herein. In some embodiments, certain elements or modules of system 200 can perform various procedures, processes, and/or activities. In these or other embodiments, the procedures, processes, and/or activities can be performed by other suitable elements or modules of system 200.

Generally speaking, system 200 can be implemented with hardware and/or software. Part or all of the hardware and/or software implemented in system 200 can be conventional or part or all of the hardware and/or software can be customized (e.g., optimized) for implementing part or all of the functionality of system 200 described herein.

System 200 can include a web server 201 and/or web devices 202, 203 can each be a computer system, such as computer system 300 (FIG. 3), and can each be a single computer, a single server, a cluster or collection of computers or servers, or a cloud of computers or servers. A single computer system can also host each of two or more of web server 201 and/or web devices 202, 203.

Web Devices 202, 203 can comprise any of the elements described in relation to computer system 100 (FIG. 1). For example, web devices 202, 203 can be mobile electronic devices. A mobile electronic device can refer to a portable electronic device (e.g., an electronic device easily conveyable by hand by a person of average size) with the capability to present audio and/or visual data (e.g., text, images, videos, music, etc.). For example, a mobile electronic device can comprise at least one of a digital media player, a cellular telephone (e.g., a smartphone), a personal digital assistant, a handheld digital computer device (e.g., a tablet personal computer device), a laptop computer device (e.g., a notebook computer device, a netbook computer device), a wearable user computer device, or another portable computer device with the capability to present audio and/or visual data (e.g., images, videos, music, etc.). Thus, in many examples, a mobile electronic device can comprise a volume and/or weight sufficiently small as to permit the mobile electronic device to be easily conveyable by hand. For examples, in some embodiments, a mobile electronic device can occupy a volume of less than or equal to approximately 1790 cubic centimeters, 2434 cubic centimeters, 2876 cubic centimeters, 4056 cubic centimeters, and/or 5752 cubic centimeters. Further, in these embodiments, a mobile electronic device can weigh less than or equal to 15.6 Newtons, 17.8 Newtons, 22.3 Newtons, 31.2 Newtons, and/or 44.5 Newtons.

Exemplary mobile electronic devices can comprise (i) an iPod®, iPhone®, iTouch®, iPad®, MacBook® or similar product by Apple Inc. of Cupertino, California, United States of America, (ii) a Blackberry® or similar product by Research in Motion (RIM) of Waterloo, Ontario, Canada, (iii) a Lumia® or similar product by the Nokia Corporation of Keilaniemi, Espoo, Finland, and/or (iv) a Galaxy™ or similar product by the Samsung Group of Samsung Town, Seoul, South Korea. Further, in the same or different embodiments, a mobile electronic device can comprise an electronic device configured to implement one or more of (i) the iPhone® operating system by Apple Inc. of Cupertino, California, United States of America, (ii) the Blackberry® operating system by Research In Motion (RIM) of Waterloo, Ontario, Canada, (iii) the Palm® operating system by Palm, Inc. of Sunnyvale, California, United States, (iv) the Android™ operating system developed by the Open Handset Alliance, (v) the Windows Mobile™ operating system by Microsoft Corp. of Redmond, Washington, United States of America, or (vi) the Symbian™ operating system by Nokia Corp. of Keilaniemi, Espoo, Finland.

Further still, the term “wearable user computer device” as used herein can refer to an electronic device with the capability to present audio and/or visual data (e.g., text, images, videos, music, etc.) that is configured to be worn by a user and/or mountable (e.g., fixed) on the user of the wearable user computer device (e.g., sometimes under or over clothing; and/or sometimes integrated with and/or as clothing and/or another accessory, such as, for example, a hat, eyeglasses, a wrist watch, shoes, etc.). A wearable user computer device can comprise a mobile electronic device, and vice versa. However, a wearable user computer device does not necessarily comprise a mobile electronic device, and vice versa.

In specific examples, a wearable user computer device can comprise a head mountable wearable user computer device (e.g., one or more head mountable displays, one or more eyeglasses, one or more contact lenses, one or more retinal displays, etc.) or a limb mountable wearable user computer device (e.g., a smart watch, smart ring, etc.). In these examples, a head mountable wearable user computer device can be mountable in close proximity to one or both eyes of a user of the head mountable wearable user computer device and/or vectored in alignment with a field of view of the user.

In more specific examples, a head mountable wearable user computer device can comprise (i) Google Glass™ product or a similar product by Google Inc. of Menlo Park, California, United States of America; (ii) the Eye Tap™ product, the Laser Eye Tap™ product, or a similar product by ePI Lab of Toronto, Ontario, Canada, and/or (iii) the Raptyr™ product, the STAR 1200™ product, the Vuzix Smart Glasses M100™ product, or a similar product by Vuzix Corporation of Rochester, New York, United States of America. In other specific examples, a head mountable wearable user computer device can comprise the Virtual Retinal Display™ product, or similar product by the University of Washington of Seattle, Washington, United States of America. Meanwhile, in further specific examples, a limb mountable wearable user computer device can comprise the iWatch™ product, or similar product by Apple Inc. of Cupertino, California, United States of America, the Galaxy Gear or similar product of Samsung Group of Samsung Town, Seoul, South Korea, the Moto 360 product or similar product of Motorola of Schaumburg, Illinois, United States of America, and/or the Zip™ product, One™ product, Flex™ product, Charge™ product, Surge™ product, or similar product by Fitbit Inc. of San Francisco, California, United States of America.

Web server 201 and/or web devices 202, 203 can each comprise one or more input devices (e.g., one or more keyboards, one or more keypads, one or more pointing devices such as a computer mouse or computer mice, one or more touchscreen displays, a microphone, etc.), and/or can each comprise one or more display devices (e.g., one or more monitors, one or more touch screen displays, projectors, etc.). In these or other embodiments, one or more of the input device(s) can be similar or identical to input device 303 (FIG. 3). Further, one or more of the display device(s) can be similar or identical to display device 305 (FIG. 3). The input device(s) and the display device(s) can be coupled to the processing module(s) and/or the memory storage module(s) of web server 201 and/or web devices 202, 203 in a wired manner and/or a wireless manner, and the coupling can be direct and/or indirect, as well as locally and/or remotely. As an example of an indirect manner (which may or may not also be a remote manner), a keyboard-video-mouse (KVM) switch can be used to couple the input device(s) and the display device(s) to the processing module(s) and/or the memory storage module(s). In some embodiments, the KVM switch also can be part of web server 201 and/or web devices 202, 203. In a similar manner, the processing module(s) and the memory storage module(s) can be local and/or remote to each other.

Generally speaking, web server 201 can host one or more websites. For example, web server 201 can host a website for finding apartments and/or roommates. In addition to websites, many platforms can comprise a mobile application that allow users to search for apartments and/or roommates via an app based interface in addition to and/or as an alternative to a website. In many embodiments, the website can comprise an apartment listing website. Apartment listing websites can consolidate rental property information from multiple sources into a unified platform. These apartment listing websites can feature searchable databases of listings comprising various property types, price ranges, and geographic locations. Users can apply filters, (e.g., location, rental price, number of bedrooms, and/or amenities) to narrow their search results. also integrate map-based search interfaces to provide a geographic overview of available properties. Apartment listing websites can be operated by property management companies and/or focus on properties managed by a specific company or group. Apartment listing websites can also enable individual property owners to list their rental units and communicate directly with interested renters.

Roommate matching websites can facilitate a process of finding compatible roommates based on user preferences, shared interests, and housing requirements. Roommate matching websites can comprise user profiles that include information about user's lifestyle, habits, and preferences (e.g., cleanliness levels, work schedules, and/or smoking preferences). Advanced matching algorithms (e.g., those described in method 100 (FIG. 1)) are often used to suggest compatible roommates based on profile data and/or questionnaires. Roommate websites can allow users to post advertisements describing the available space and the type of roommate they are seeking. Many apartment listing websites can comprise roommate-finding functionalities as a supplemental and/or additional service. These platforms can integrate roommate searches with apartment listings, thereby enabling users to find both housing and potential roommates simultaneously. Features may include filters for budget, location, housing type, and roommate compatibility tools (e.g., those described in method 100 (FIG. 1)).

Web server 201 and/or web devices 202, 203 can communicate or interface (e.g., interact) with one another through internet 220. Internet 220 can be an intranet that is not open to the public, a mesh network of individual systems, and/or a distributed system. Accordingly, in many embodiments, web server 201 (and/or the software used by such systems) can refer to a back end of system 200 operated by an operator and/or administrator of system 200, and web devices 202, 203 (and/or the software used by such systems) can refer to a front end of system 200 used by one or more users. An operator and/or administrator of system 200 can manage system 200, the processing module(s) of system 200, and/or the memory storage module(s) of system 200 using the input device(s) and/or display device(s) of system 200.

Web server 201 and/or web devices 202, 203 also can be configured to communicate with one or more databases. The one or more databases can comprise a property database that contains information about properties offered on a rental and/or roommate finding platform. Databases can also comprise an interaction database containing information about interactions of web devices 202, 203 with a GUI. For example, the one or more databases can store past (e.g., historical) interactions of user web devices 202, 203 with a rental and/or roommate finding platform. These interactions can be tied to a unique identifier (e.g., an IP address, an advertising ID, device ID, etc.) and/or a user account. In embodiments where a user interacts with a GUI before logging into a user account, data stored in the one or more database that is associated with a unique identifier can be merged with and/or associated with data associated with the user account. Data can be deleted from a database when it becomes older than a maximum age, which can be set by an administrator of system 200. Data collected in real-time can be streamed to a database for storage, thereby increasing a storage speed of a database.

The one or more databases can be stored on one or more memory storage modules (e.g., non-transitory memory storage module(s)), which can be similar or identical to the one or more memory storage module(s) (e.g., non-transitory memory storage module(s)) described above with respect to computer system 300 (FIG. 3). Further, the one or more databases can each be stored on a single memory storage module of the memory storage module(s), and/or the non-transitory memory storage module(s) storing the one or more databases or the contents of that particular database can be spread across multiple ones of the memory storage module(s) and/or non-transitory memory storage module(s) storing the one or more databases, depending on the size of the particular database and/or the storage capacity of the memory storage module(s) and/or non-transitory memory storage module(s). In various embodiments, databases can be stored in a cache (e.g., MegaCache) for immediate retrieval on-demand. The one or more databases can each comprise a structured (e.g., indexed) collection of data and can be managed by any suitable database management systems configured to define, create, query, organize, update, and manage database(s). Exemplary database management systems can include MySQL (Structured Query Language) Database, PostgreSQL Database, Microsoft SQL Server Database, Oracle Database, SAP (Systems, Applications, & Products) Database, IBM DB2 Database, and/or NoSQL Database.

Meanwhile, communication between web server 201, web devices 202, 203, and/or the one or more databases can be implemented using any suitable manner of wired and/or wireless communication. Accordingly, system 200 can comprise any software and/or hardware components configured to implement the wired and/or wireless communication. Further, the wired and/or wireless communication can be implemented using any one or any combination of wired and/or wireless communication network topologies (e.g., ring, line, tree, bus, mesh, star, daisy chain, hybrid, etc.) and/or protocols (e.g., personal area network (PAN) protocol(s), local area network (LAN) protocol(s), wide area network (WAN) protocol(s), cellular network protocol(s), powerline network protocol(s), etc.). Exemplary PAN protocol(s) can comprise Bluetooth, Zigbee, Wireless Universal Serial Bus (USB), Z-Wave, etc.; exemplary LAN and/or WAN protocol(s) can comprise Institute of Electrical and Electronic Engineers (IEEE) 802.3 (also known as Ethernet), IEEE 802.11 (also known as WiFi), etc.; and exemplary wireless cellular network protocol(s) can comprise Global System for Mobile Communications (GSM), General Packet Radio Service (GPRS), Code Division Multiple Access (CDMA), Evolution-Data Optimized (EV-DO), Enhanced Data Rates for GSM Evolution (EDGE), Universal Mobile Telecommunications System (UMTS), Digital Enhanced Cordless Telecommunications (DECT), Digital AMPS (IS-136/Time Division Multiple Access (TDMA)), Integrated Digital Enhanced Network (iDEN), Evolved High-Speed Packet Access (HSPA+), Long-Term Evolution (LTE), WiMAX, etc. The specific communication software and/or hardware implemented can depend on the network topologies and/or protocols implemented, and vice versa. In many embodiments, exemplary communication hardware can comprise wired communication hardware including, for example, one or more data buses, such as, for example, universal serial bus(es), one or more networking cables, such as, for example, coaxial cable(s), optical fiber cable(s), and/or twisted pair cable(s), any other suitable data cable, etc. Further exemplary communication hardware can comprise wireless communication hardware including, for example, one or more radio transceivers, one or more infrared transceivers, etc. Additional exemplary communication hardware can comprise one or more networking components (e.g., modulator-demodulator components, gateway components, etc.).

Turning ahead in the drawings, FIG. 3 illustrates a block diagram of a system 300 that can be employed for matching users over a computer network, as described in greater detail below. System 300 is merely exemplary and embodiments of the system are not limited to the embodiments presented herein. System 300 can be employed in many different embodiments or examples not specifically depicted or described herein. In some embodiments, certain elements or modules of system 300 can perform various procedures, processes, and/or activities. In these or other embodiments, the procedures, processes, and/or activities can be performed by other suitable elements or modules of system 300.

Generally speaking, system 300 can be implemented with hardware and/or software. Part or all of the hardware and/or software implemented in system 300 can be conventional or part or all of the hardware and/or software can be customized (e.g., optimized) for implementing part or all of the functionality of system 300 described herein. When implemented as software, one or more elements of system 300 can be emulated (e.g., reproduced functionally and/or by action via software). For example, a virtual machine having one or more elements described below can be instantiated on one or more elements of system 200 (FIG. 2).

When implemented as hardware, one or more of the elements of system 300 can be coupled together using one or more chassis configured to hold one or more circuit boards and/or serial bus(es). These boards and buses allow the various elements of system 300 to communicate amongst each other to accomplish their intended purposes. While elements of system 300 are described below individually, each can also be integrated into one or more chassis, circuit boards, and/or buses of system 300. On the other hand, one or more elements of system 300 can also be removable (e.g., via a PCI slot on a motherboard and/or a USB port). One or mor elements of system 300 may also be integrated and/or embedded in a different machine or manufacture. Although specific constructions of boards and buses within system 300 are not shown, it should be understood that their construction can be tied to a form factor selected for system 300.

System 300 can take a number of different form factors based on its implementation. For example, system 300 can be implemented as a desktop computer, a laptop computer, a mobile device, and/or a wearable device as described herein. Further, system 300 can comprise a single computer, a single server, a cluster or collection of computers or servers, or a cloud of computers or servers. Typically, a cluster or collection of servers can be used when the demand on 300 exceeds the reasonable capability of a single server or computer, when a distributed structure for system 300 is desired, and/or when parallel computing is desired.

In many embodiments, system 300 can comprise a processor 301, a memory storage 302, an input device 303, a graphics adapter 304, a display device 305, a graphical user interface (GUI) 306, a network adapter 307, GPS 308, and/or an audio output 309.

Generally speaking, processor 301 can comprise any type of computational circuit. For example, processor 301 can comprise a microprocessor, a microcontroller, a controller, a complex instruction set computing (CISC) microprocessor, a reduced instruction set computing (RISC) microprocessor, a very long instruction word (VLIW) microprocessor, a graphics processor, a digital signal processor, application specific integrated circuits (ASICs), etc. Processor 301 can be configured to implement (e.g., run) computer instructions (e.g., program instructions) stored on memory devices in system 300. At least a portion of the program instructions, stored on these devices, can be suitable for carrying out at least part of the techniques and methods described herein. Architecture and/or design of processor 301 can be compliant with any of a variety of commercially distributed architecture families. For example, a processor can have a 32-bit (x86) architecture and/or a 64-bit (x86-64, IA64, and AMD64) architecture. Processor 301 can be configured to perform parallel computing in combination with other elements of system 300 and/or additional processors. Generally speaking, parallel computing can be seen as a technique where multiple elements of system 300 are used to perform calculations simultaneously. In this way, complex and repetitive tasks (e.g., training a predictive algorithm) can be performed faster and with less processing power than without parallel computing.

Memory storage 302 can comprise non-volatile memory (e.g., read only memory (ROM)) and/or volatile memory (e.g., random access memory (RAM)). The non-volatile memory can be removable and/or non-removable non-volatile memory. Meanwhile, RAM can comprise dynamic RAM (DRAM), static RAM (SRAM), or some other type of RAM. Further, ROM can include mask-programmed ROM, programmable ROM (PROM), one-time programmable ROM (OTP), erasable programmable read-only memory (EPROM), electrically erasable programmable ROM (EEPROM) (e.g., electrically alterable ROM (EAROM) and/or flash memory), or some other type of ROM. Memory storage 302 can comprise non-transitory memory and/or transitory memory. All or a portion of memory storage 302 can be referred to as memory storage module(s) and/or memory storage device(s). Memory storage 302 can have a number of form factors when used in system 300. For example, memory storage 302 can comprise a magnetic disk hard drive, a solid state hard drive, a removable USB storage drive, a RAM chip, etc.

Memory storage 302 can be encoded with a wide variety of computer code configured to operate system 300. For example, portions of memory storage 302 can be encoded with a boot code sequence suitable for restoring system 300 to a functional state after a system reset. As another example, portions of memory storage 302 can comprise microcode such as a Basic Input-Output System (BIOS) operable with elements of system 300. Further, portions of the memory storage 302 can comprise an operating system (e.g., a software program that manages the hardware and software resources of a computer and/or a computer network). The BIOS can be configured to initialize and test components of system 300 and load the operating system. Meanwhile, the operating system can perform basic tasks such as, for example, controlling and allocating memory, prioritizing the processing of instructions, controlling input and output devices, facilitating networking, and/or managing files. Exemplary operating systems can comprise software within the Microsoft® Windows®, Mac OS®, Apple® iOS®, Google® Android®, UNIX®, and/or Linux® series of operating systems.

Input device 303 can be configured to allow a user to interact and/or control elements of system 300. A number of devices and be used as input device 303 alone or in combination. For example, input device 303 can comprise a keyboard, a mouse, a touch screen, a microphone, a camera, etc. Input device 303 can be coupled to other elements of system 300 in a number of ways. For example, input device 303 can be coupled via a Universal Serial Bus (USB) port in a wired and/or wireless manner or via a specialized port (e.g., a PS/2 port) depending on the specific device. User inputs through input device 303 can come in a number of forms. For example, when input device 303 comprises a microphone, user input can be received via voice commands and/or a speech to text algorithm. As another example, when input device 303 comprises a camera, user input can be received via bodily movements that are captured and interpreted by system 300.

Graphics adapter 304 can be configured to receive and/or generate one or more elements for display on display device 305. Exemplary embodiments of graphics adapter 304 can comprise devices within the NVIDIA® GeForce® and/or the AMD® RX® series of video cards. In many embodiments, a chipset present on graphics adapter 304 can be configured to perform similar, simultaneous computations in a manner more efficient than other chipsets. For example, rendering a 3D scene on graphics adapter 304 can involve repeated geometric calculations performed in parallel to generate the 3D scene. As another example, repeated mathematical calculations involved in training a predictive algorithm can be performed in parallel on graphics adapter 304 more efficiently thank on processor 301. Display device 305 can receive and display signals from graphics adapter 304. A number of devices can be used as display device 305. For example, display device 305 can comprise a computer monitor, a television, a touch screen display, etc.

In some embodiments, display device 305 can optionally display graphical user interface (GUI) 306. GUI 306 can be a part of and/or displayed by web server 201 (FIG. 2) and/or web devices 202, 203 (FIG. 2). With regards to form, GUI 306 can comprise text and/or graphics (image) based user interfaces. GUI 306 can be color, black and white, and/or greyscale. GUI 306 can be implemented as an application running on a computer system, such as web server 201 (FIG. 2) and/or web devices 202, 203 (FIG. 2). GUI 306 can also comprise a website accessed through a network (e.g., internet 220 (FIG. 2)). For example, GUI 306 can comprise an apartment and/or roommate finding website. When GUI 306 allows for modification and/or changes to one or more settings in system 300, it can be referred to as an administrative (e.g., back end) GUI. GUI 306 can also be displayed as or on a virtual reality (VR) and/or augmented reality (AR) system or display. GUI 306 can receive a number of interactions from a user via input device 303. For example, an interaction with a GUI can comprise a click, a look, a selection, a grab, a view, a purchase, a bid, a swipe, a pinch, a reverse pinch, etc.

Network adapter 307 can be configured to connect system 300 to a computer network by wired communication (e.g., a wired network adapter) and/or wireless communication (e.g., a wireless network adapter). Network adapter 307 can be integrated into one or more chassis, circuit boards, and/or buses or be removable (e.g., via a PCI slot on a motherboard). For example, network adapter 307 can be implemented via one or more dedicated communication chips configured to receive various protocols of wired and/or wireless communications.

GPS 308 can comprise a chipset and/or module configured to communicate with a satellite based location system configured to provide location and time information. (e.g., GPS 230). This location and time information can then be used to determine a location of system 300. Audio output 309 can be configured to receive and/or generate one or more audio signals for play through a speaker. Exemplary audio outputs 309 can comprise an audio card.

For simplicity and clarity of illustration, the drawing figures illustrate the general manner of construction, and descriptions and details of some features and techniques may be omitted to avoid unnecessarily obscuring the present disclosure. Additionally, elements in the drawing figures are not necessarily drawn to scale. For example, the dimensions of some of the elements in the figures may be exaggerated relative to other elements to help improve understanding of embodiments of the present disclosure. The same reference numerals in different figures denote the same elements.

The terms “first,” “second,” “third,” “fourth,” and the like in the description and in the claims, if any, are used for distinguishing between similar elements and not necessarily for describing a particular sequential or chronological order. It is to be understood that the terms so used are interchangeable under appropriate circumstances such that the embodiments described herein are, for example, capable of operation in sequences other than those illustrated or otherwise described herein. Furthermore, the terms “include,” and “have,” and any variations thereof, are intended to cover a non-exclusive inclusion, such that a process, method, system, article, device, or apparatus that comprises a list of elements is not necessarily limited to those elements, but may include other elements not expressly listed or inherent to such process, method, system, article, device, or apparatus.

The terms “left,” “right,” “front,” “back,” “top,” “bottom,” “over,” “under,” and the like in the description and in the claims, if any, are used for descriptive purposes and not necessarily for describing permanent relative positions. It is to be understood that the terms so used are interchangeable under appropriate circumstances such that the embodiments of the apparatus, methods, and/or articles of manufacture described herein are, for example, capable of operation in other orientations than those illustrated or otherwise described herein.

The terms “couple,” “coupled,” “couples,” “coupling,” and the like should be broadly understood and refer to connecting two or more elements mechanically and/or otherwise. Two or more electrical elements may be electrically coupled together, but not be mechanically or otherwise coupled together. Coupling may be for any length of time, e.g., permanent or semi-permanent or only for an instant. “Electrical coupling” and the like should be broadly understood and include electrical coupling of all types. The absence of the word “removably,” “removable,” and the like near the word “coupled,” and the like does not mean that the coupling, etc. in question is or is not removable.

As defined herein, two or more elements are “integral” if they are comprised of the same piece of material. As defined herein, two or more elements are “non-integral” if each is comprised of a different piece of material.

As defined herein, “real-time” can, in some embodiments, be defined with respect to operations carried out as soon as practically possible upon occurrence of a triggering event. A triggering event can include receipt of data necessary to execute a task or to otherwise process information. Because of delays inherent in transmission and/or in computing speeds, the term “real time” encompasses operations that occur in “near” real time or somewhat delayed from a triggering event. In a number of embodiments, “real time” can mean real time less a time delay for processing (e.g., determining) and/or transmitting data. The particular time delay can vary depending on the type and/or amount of the data, the processing speeds of the hardware, the transmission capability of the communication hardware, the transmission distance, etc. However, in many embodiments, the time delay can be less than approximately one second, two seconds, five seconds, or ten seconds.

As defined herein, “approximately” can, in some embodiments, mean within plus or minus ten percent of the stated value. In other embodiments, “approximately” can mean within plus or minus five percent of the stated value. In further embodiments, “approximately” can mean within plus or minus three percent of the stated value. In yet other embodiments, “approximately” can mean within plus or minus one percent of the stated value.

Although systems and methods for matching users over a computer have been described with reference to specific embodiments, it will be understood by those skilled in the art that various changes may be made without departing from the spirit or scope of the disclosure. Accordingly, the disclosure of embodiments is intended to be illustrative of the scope of the disclosure and is not intended to be limiting. It is intended that the scope of the disclosure shall be limited only to the extent required by the appended claims. For example, to one of ordinary skill in the art, it will be readily apparent that any element of FIGS. 1-5 may be modified, and that the foregoing discussion of certain of these embodiments does not necessarily represent a complete description of all possible embodiments. For example, one or more of the procedures, processes, or activities of FIG. 1 may include different procedures, processes, and/or activities and be performed by many different modules, in many different orders.

All elements claimed in any particular claim are essential to the embodiment claimed in that particular claim. Consequently, replacement of one or more claimed elements constitutes reconstruction and not repair. Additionally, benefits, other advantages, and solutions to problems have been described with regard to specific embodiments. The benefits, advantages, solutions to problems, and any element or elements that may cause any benefit, advantage, or solution to occur or become more pronounced, however, are not to be construed as critical, required, or essential features or elements of any or all of the claims, unless such benefits, advantages, solutions, or elements are stated in such claim.

Moreover, embodiments and limitations disclosed herein are not dedicated to the public under the doctrine of dedication if the embodiments and/or limitations: (1) are not expressly claimed in the claims; and (2) are or are potentially equivalents of express elements and/or limitations in the claims under the doctrine of equivalents.

What is claimed is:

1. A system comprising:
one or more processors; and
one or more non-transitory memories storing computing instructions configured to communicate with the one or more processors and cause the one or more processors to perform:
receiving one or more prompt answers to one or more prompts from a user device;
calculating one or more trait scores using the one or more prompts;
calculating one or more compatibility scores between a first user and a second user;
normalizing the one or more compatibility scores; and
coordinating displaying the one or more normalized compatibility scores.

2. The system of claim 1, wherein the computing instructions are further configured to cause the one or more processors to perform coordinating displaying one or more prompts to the first user and the second user.

3. The system of claim 1, wherein the computing instructions are further configured to cause the one or more processors to perform applying one or more reverse score functions to the one or more prompt answers.

4. The system of claim 1, wherein the computing instructions are further configured to cause the one or more processors to perform applying one or more weighting algorithms to the one or more compatibility scores.

5. The system of claim 4, wherein the computing instructions are further configured to cause the one or more processors to perform calculating one or more weighted similarity scores between the first user and the second user.

6. The system of claim 1, wherein the calculating one or more trait scores comprises averaging the one or more trait scores.

7. The system of claim 1, wherein the normalized and compatibility scores are displayed as a percentage.

8. A method comprising:
receiving one or more prompt answers to one or more prompts from a user device;
calculating one or more trait scores using the one or more prompts;
calculating one or more compatibility scores between a first user and a second user;
normalizing the one or more compatibility scores; and
coordinating displaying the one or more normalized compatibility scores.

9. The method of claim 8 further comprising coordinating displaying one or more prompts to the first user and the second user.

10. The method of claim 8 further comprising applying one or more reverse score functions to the one or more prompt answers.

11. The method of claim 8 further comprising applying one or more weighting algorithms to the one or more compatibility scores.

12. The method of claim 11 further comprising calculating one or more weighted similarity scores between the first user and the second user.

13. The method of claim 8, wherein the calculating one or more trait scores comprises averaging the one or more trait scores.

14. The method of claim 8, wherein the normalized and compatibility scores are displayed as a percentage.

15. One or more articles of manufacture including one or more non-transitory, tangible computer readable storage mediums having instructions stored thereon that, in response to execution by one or more processors, cause the one or more processors to perform:
receiving one or more prompt answers to one or more prompts from a user device;
calculating one or more trait scores using the one or more prompts;
calculating one or more compatibility scores between a first user and a second user;
normalizing the one or more compatibility scores; and
coordinating displaying the one or more normalized compatibility scores.

16. The one or more articles of manufacture of claim 15, wherein the instructions are further configured to cause the one or more processors to perform coordinating displaying one or more prompts to the first user and the second user.

17. The one or more articles of manufacture of claim 15, wherein the instructions are further configured to cause the one or more processors to perform applying one or more reverse score functions to the one or more prompt answers.

18. The one or more articles of manufacture of claim 15, wherein the instructions are further configured to cause the one or more processors to perform applying one or more weighting algorithms to the one or more compatibility scores.

19. The one or more articles of manufacture of claim 15, wherein the instructions are further configured to cause the one or more processors to perform calculating one or more weighted similarity scores between the first user and the second user.

20. The one or more articles of manufacture of claim 15, wherein the calculating one or more trait scores comprises averaging the one or more trait scores.
